(19) United States
(12) Patent Application Publication
(10) Pub. No.: US 2006/0048797 A1
(43) Pub. Date: Mar. 9, 2006

(54) Cleaner and cleaning method using the same

(75) Inventors: Woon Sung Jung, Suwon-Si (KR); Hye Rim Lee, Suwon-Si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/171,258

(22) Filed: Jul. 1, 2005

(30) Foreign Application Priority Data
Sep. 8, 2004 (KR) 2004-0071896

(51) Int. Cl. B08B 7/04; B08B 5/04

(52) U.S. Cl. 134/21; 134/18; 15/319

(57) ABSTRACT

A cleaner and a cleaning method using the same. A cleaner having a plurality of cleaning modes, includes: a reader reading object identification data stored in an object identification medium attached to an object to be cleaned; and a control unit interpreting the object identification data read by the reader to identify a kind of the object to be cleaned and controlling the cleaner such that the cleaner performs cleaning in a cleaning mode corresponding to the identified kind of the object to be cleaned.

### CROSS-REFERENCE TO RELATED APPLICATION

This application claims the benefit of Korean Patent Application No. 2004-71896, filed on Sep. 8, 2004 in the Korean Intellectual Property Office, the disclosure of which is incorporated herein by reference.

### BACKGROUND OF THE INVENTION

1. Field of the Invention

The present invention relates to a cleaner and a cleaning method using the same, and more particularly, to a cleaner and a cleaning method using the same that is capable of automatically changing cleaning mode based on an object to be cleaned.

2. Description of Related Art

Various sizes and types of cleaners, including vacuum cleaners, are on the market. One example of a vacuum cleaner is disclosed in Korean Unexamined Patent Publication No. 2003-0056826, which discusses a vacuum cleaner including: a cleaner body having a fan to suction air, a fan motor to drive the fan, and a cyclonic dust collection unit; and a suction unit connected to the cleaner body for suctioning various foreign matter present where a cleaning operation is performed.

To the suction unit is connected an extension pipe. To the upper end of the extension pipe is connected a grip, which is connected to one end of the suction hose. The other end of the suction hose is connected to the cleaner body. At one side of the grip is disposed a control switch to turn the cleaner on/off and control a suction force of the cleaner.

When the control switch is manipulated to turn on the conventional vacuum cleaner with the above-stated construction, foreign matter, such as dust, is suctioned, together with air, through the suction unit, and is then transmitted to the cyclonic dust collection unit where the dust is separated from the air according to the principle of cyclone. The separated foreign matter is collected into a dust collection bag in the cleaner body.

When a relatively large amount of foreign matter is present or when a cleaning operation is performed on a surface from which it is difficult to suction foreign matter, such as a carpet, the control switch is manually manipulated to increase a suction force of the cleaner. In this way, the cleaning capacity of the cleaner is increased. When a relatively small amount of foreign matter is present or when a cleaning operation is performed on a surface from which it is easy to suction foreign matter, on the other hand, the control switch is also manually manipulated to decrease a suction force of the cleaner. In this way, the cleaning capacity of the cleaner is decreased.

In the subject conventional vacuum cleaner, however, the control switch is manually manipulated to control the cleaning capacity of the cleaner depending upon an object to be cleaned or the place where a cleaning operation is performed, which is very troublesome and inconvenient. Furthermore, it is difficult for a user to set cleaning capacity appropriate to every object to be cleaned, which may result in poor cleaning performance.

Especially for an automatic robot cleaner, a cleaning operation is performed based on specified cleaning mode irrespective of a type an object to be cleaned, and therefore, appropriate cleaning is not accomplished. For example, the automatic robot cleaner performs a cleaning operation in the same cleaning mode irrespective of whether to clean a floor covered with laminated paper or a carpet, which is more difficult to clean than the floor covered with laminated paper. As a result, for example, the flat floor such as a laminated floor, may be well cleaned while a carpeted floor may be poorly cleaned.

### BRIEF SUMMARY

Therefore, it is an aspect of the invention to provide a cleaner and a cleaning method using the same that is capable of performing appropriate cleaning based on an object to be cleaned.

According to an aspect of the present invention, there is provided a cleaner having a plurality of cleaning modes, including: a reader reading object identification data stored in an object identification medium attached to an object to be cleaned; and a control unit interpreting the object identification data read by the reader to identify a kind of the object to be cleaned and controlling the cleaner such that the cleaner performs cleaning in a cleaning mode corresponding to the identified kind of the object to be cleaned.

According to another aspect of the present invention, there is provided a cleaner including: a radio frequency identification (RFID) reader transmitting an RF signal to an RFID tag attached to an object to be cleaned, the RFID tag having a certification number, and receiving another RF signal transmitted from the RFID tag; and a control unit interpreting the RF signal received from the RFID reader to identify a kind of the object to be cleaned and controlling the cleaner such that the cleaner performs cleaning in a cleaning mode corresponding to the identified kind of the object to be cleaned.

According to another aspect of the present invention, there is provided a cleaning method including: reading object identification data stored in an object identification medium and regarding an object to be cleaned; interpreting read the object identification data to identify a kind of the object to be cleaned; and controlling the cleaner to perform cleaning in a cleaning mode corresponding to the identified kind of the object to be cleaned.

According to another aspect of the present invention, there is provided a vacuum cleaning system, including: an object type provider providing a type of an object to be cleaned; a reading section reading the type of the object to be cleaned; and a control section selecting one of plural cleaning modes based on the read type of the object to be cleaned and causing a vacuum cleaner to clean the object to be cleaned in the selected cleaning mode.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a view showing a vacuum cleaner according to a first embodiment of the present invention;

FIG. 2 is a block diagram showing the construction of the vacuum cleaner shown in FIG. 1;

FIG. 3 is a view illustrating how an object to be cleaned is identified by the vacuum cleaner shown in FIGS. 1 and 2;

FIG. 4 is a flow chart illustrating a cleaning process of the vacuum cleaner shown in FIGS. 1 and 2;

FIG. 5 is a view showing a vacuum cleaner according to a second embodiment of the present invention;

FIG. 6 is a block diagram showing the construction of the vacuum cleaner shown in FIG. 5;

FIG. 7 is a view illustrating how an object to be cleaned is identified by the vacuum cleaner shown in FIGS. 5 and 6;

FIG. 8 is a flow chart illustrating a cleaning process of the vacuum cleaner shown in FIGS. 5 and 6; and

FIG. 9 is a view showing an automatic robot cleaner according to a third embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

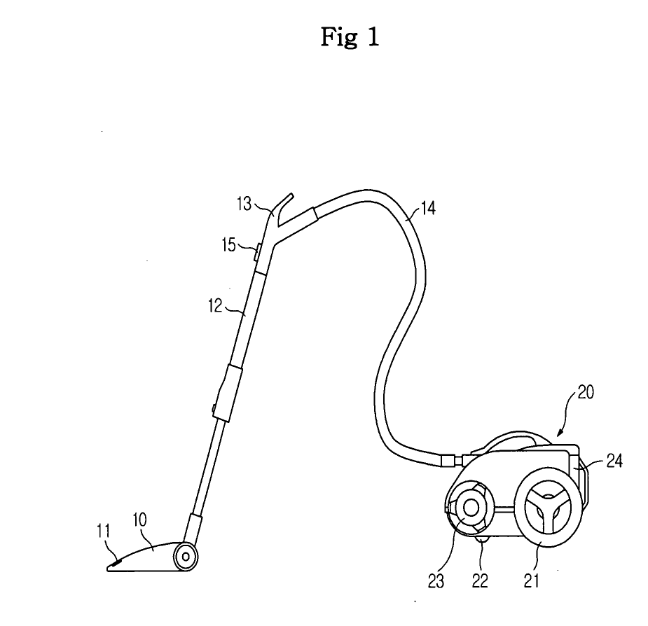

Referring to FIG. 1, a vacuum cleaner according to a first embodiment of the present invention includes: a suction unit 10 to suction various foreign matter present where a cleaning operation is performed; and a cleaner body 20 connected to the suction unit 10 by a plurality of connection members.

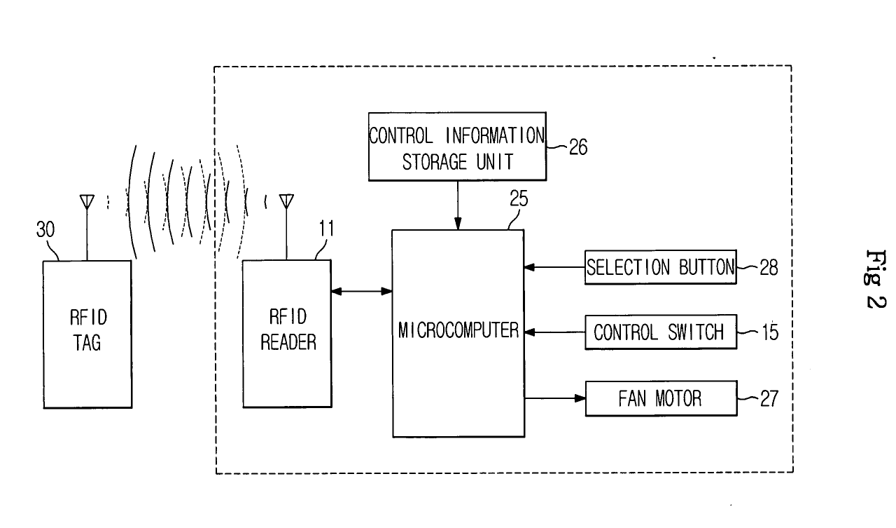

As shown in FIG. 1, the suction unit 10 has a radio frequency identification (RFID) reader 11, which transmits a radio frequency (RF) signal to the interior of a room and receives another RF signal from an RFID tag 30 (shown in FIG. 2) mounted to an object to be cleaned, such as a carpet, a laminate floor, or a wooden floor, transmitted in response to the RF signal transmitted to the interior of the room. While the RFID reader is shown to be on the suction unit it is to be understood, however, that the RFID reader 11 may be mounted to other parts of the vacuum cleaner.

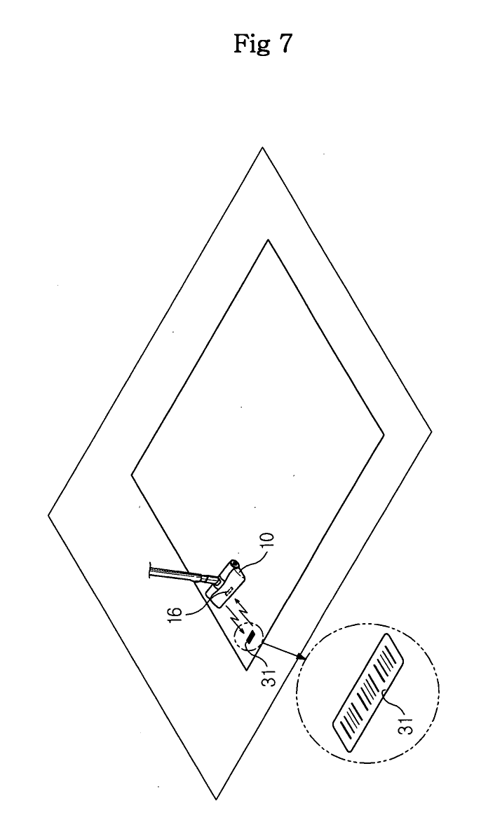

In the cleaner body 20 is mounted a fan (not shown) to suction air containing foreign matter, including dust, a fan motor 27 (FIGS. 2 and 7) to drive the fan, and a dust collection unit (not shown) to separate foreign matter from air. To both sides of the cleaner body 20 are attached wheels 21 to enable the cleaner body 20 to move, respectively.

To the bottom of the cleaner body 20 is mounted a roller caster 22 to enable the cleaner body 20 to rotate right and left while the cleaner body 20 moves back and forth. To one side of the cleaner body 20 adjacent to the front of the cleaner body 20 is attached a ventilation filter 23 to filter air separated from foreign matter and discharge the air out of the cleaner body 20.

The plural connection members include: an extension pipe 12 connected to the suction unit 10; and a extension hose 14 connected to the cleaner body 20. The extension pipe 12 and the extension hose 14 are connected to each other via a grip 13. At one side of the grip 13 is disposed a control switch 15 to turn the cleaner on/off and control a suction force of the cleaner.

Referring to FIG. 2, the vacuum cleaner according to the first embodiment of the present invention also includes: a control information storage unit 26 to store control information containing a plurality of cleaning modes corresponding to objects to be cleaned and driving levels of the components of the cleaner; a microcomputer 25 to control operation of the cleaner; and a selection button 28 to select automatic cleaning or manual cleaning. When the automatic cleaning is selected, the cleaning modes of the cleaner are automatically changed based on objects to be cleaned. When the manual cleaning is selected, the cleaning capacity of the cleaner is controlled through the user's manipulation of the control switch 15 of FIG. 1.

The control information storage unit 26 contains driving levels of components of the cleaner that are set based on the cleaning modes as indicated in Table 1. In this embodiment, only revolutions per minute of the fan motor 27 is set, although the driving levels of the other component may be set based on the cleaning modes.

TABLE 1

| Kinds of objects | | Revolutions per |
|---|---|---|
| to be cleaned | Cleaning modes | minute of fan motor |
| Floor covered with | Laminated paper covered | A |
| laminated paper | floor mode | |
| Carpet | Carpet mode | 1.5 A |
| Sofa | Sofa mode | 1.2 A |

Referring to FIGS. 1 and 2, assuming that revolutions per minute of the fan motor 27 is A (where, A is constant) in the laminated covered floor mode for cleaning the floor covered with laminated paper on which foreign matter is easily suctioned through the suction unit 10 of the vacuum cleaner, revolutions per minute of the fan motor 27 are increased in the carpet mode for cleaning the carpet on which suctioning foreign matter through the suction unit 10 is harder than on the floor cover with laminated paper such that the revolutions per minute of the fan motor 27 in the carpet mode are larger than those of the fan motor 27 in the laminated paper covered floor mode. In this way, the suction force of the vacuum cleaner is increased to perform cleaning appropriate to each object to be cleaned.

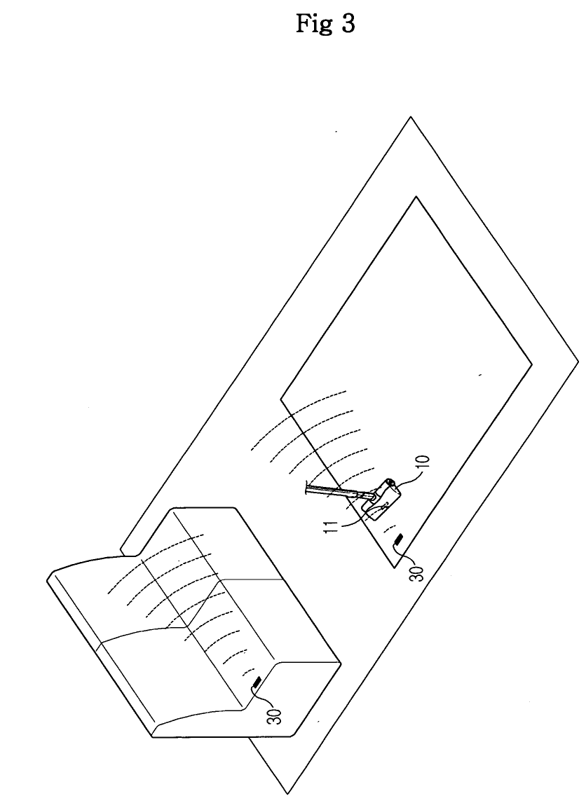

Referring to FIG. 3, the RFID reader 11 receives an RF signal transmitted from the RFID tag 30 attached to each object to be cleaned, such as the carpet or sofa. In this way, the vacuum cleaner shown in FIGS. 1 and 2 identifies the object to be cleaned.

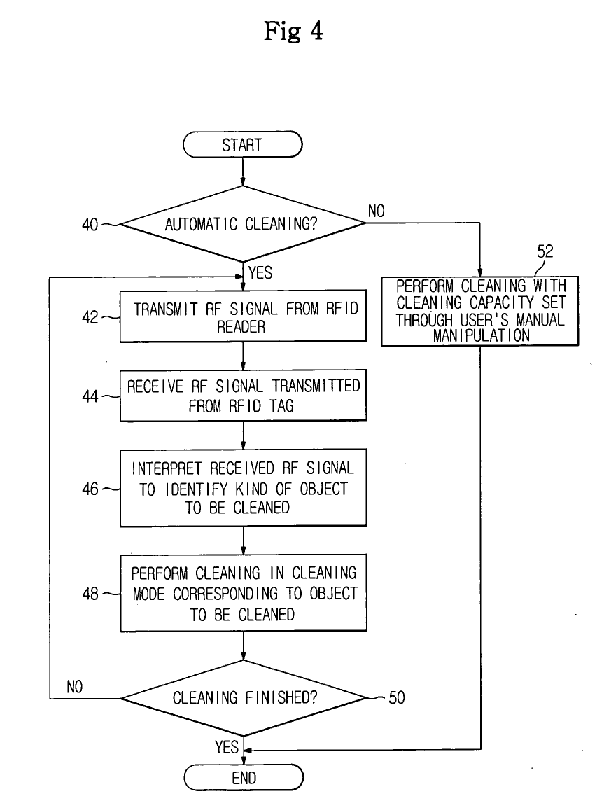

A cleaning process using the vacuum cleaner according to the first embodiment of the present invention will be described hereinafter with reference to FIG. 4. When cleaning is started, it is determined whether the automatic cleaning or the manual cleaning is to be performed (operation 40). When it is determined that the manual cleaning is to be performed, the cleaning is performed with the cleaning capacity of the cleaner (i.e., suction force of the vacuum cleaner) set through the user's manipulation of the control switch 15 (operation 52).

When it is determined that the automatic cleaning is to be performed, the RFID reader 11 transmits an RF signal to the interior of a room to identify an object to be cleaned (operation 42), and receives another RF signal that the RFID tag 30 transmits in response to the RF signal transmitted from the RFID reader 11 (operation 44).

The RFID reader 11 converts the RF signal received from the RFID tag 30 into a digital signal, and then performs cycle redundancy check (CRC) to determine whether normal object identification data has been transmitted. When it is determined that the normal object identification data has been transmitted, the data is transmitted to the microcomputer 25. The normal object identification data is an inherent certification number assigned to each RFID tag 30.

The microcomputer 25 interprets the received object identification data to identify kind of the object to be cleaned (operation 46). To this end, the microcomputer 25 stores certification numbers corresponding to the respective objects to be cleaned. For example, the microcomputer 25 stores information indicating that the object to be cleaned is a carpet when the received certification numbers are 001˜010, and the object to be cleaned is a floor covered with laminated paper when the received certification numbers are 011˜020.

After the kind of the object to be cleaned is identified, the microcomputer 25 performs cleaning in the cleaning mode corresponding to each object to be cleaned with reference to Table 1 of the control information storage unit 26 (operation 48), and then it is determined whether the cleaning has been finished (operation 50). When the cleaning has not yet finished, operation 42 is repeated.

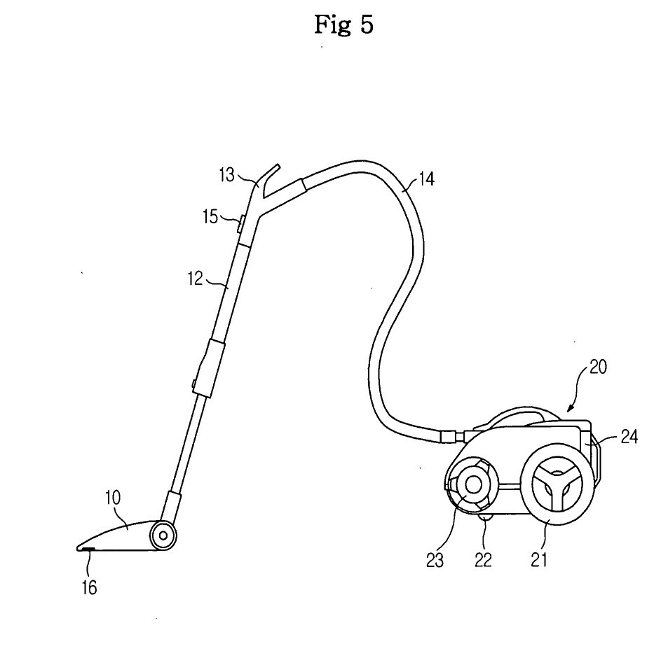

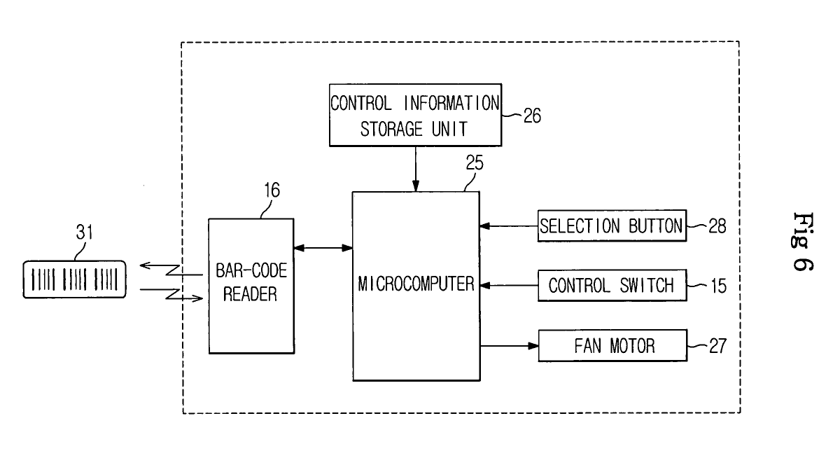

Referring to FIGS. 5 to 7, a vacuum cleaner according to a second embodiment of the present invention uses a bar code 31, instead of the RFID tag 30 used in the first embodiment, as an object identification medium to identify an object to be cleaned.

In the second embodiment, the bar code 31 is attached to each object to be cleaned, and a bar-code reader 16 is mounted to the bottom of the suction unit 10. The bar-code reader 16 reads the bar code 31 to identify the object to be cleaned. Other components of the vacuum cleaner according to the second embodiment correspond to those of the vacuum cleaner according to the first embodiment, and therefore, a detailed description thereof is omitted.

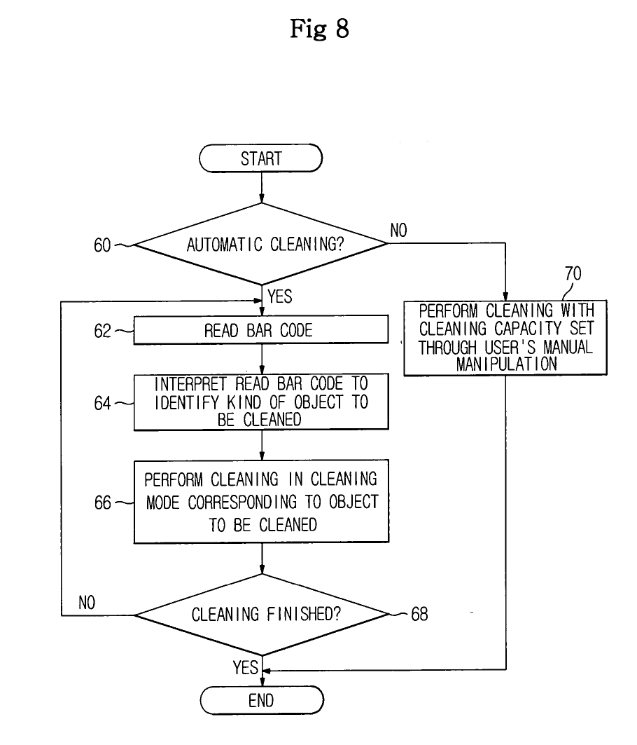

A cleaning process using the vacuum cleaner according to the second embodiment of the present invention will be described hereinafter with reference to FIG. 8.

When cleaning is started, it is determined whether the automatic cleaning or the manual cleaning is to be performed (operation 60). When it is determined that the manual cleaning is to be performed, the cleaning is performed with the cleaning capacity of the cleaner (i.e., suction force of the vacuum cleaner) set through the user's manipulation of a control switch (operation 70).

When it is determined that the automatic cleaning is to be performed after operation 60, the bar-code reader 16 reads the bar code 31, which is the object identification data (operation 62), and transmits the read bar-code information to the microcomputer 25.

The microcomputer 25 interprets the received bar-code information to identify kind of the object to be cleaned (operation 64). To this end, the microcomputer 25 stores bar-code information corresponding to the respective objects to be cleaned. For example, three bits of storage spaces are assigned to indicate kinds of objects to be cleaned. The microcomputer 25 stores information indicating that the object to be cleaned is a carpet when the received bar-code information is 001˜010, and the object to be cleaned is a floor covered with laminated paper when the received bar-code information is 011˜101. Operation 66 and operation 68 of FIG. 8 respectively correspond to operation 48 and operation 50 of FIG. 4.

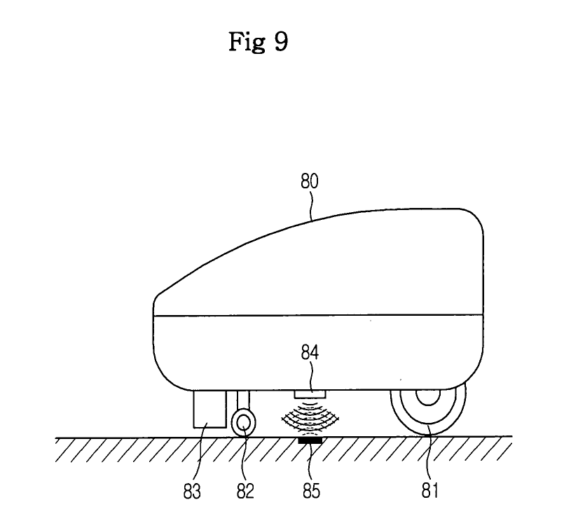

FIG. 9 is a view showing an automatic robot cleaner according to a third embodiment of the present invention. As shown in FIG. 9, the automatic robot cleaner includes: a cleaner body 80; a roller caster 82 and wheels 81 mounted to the bottom of the cleaner body 80 for enabling the cleaner body 80 to move; and a dust suction port 83 and an RFID reader 84 mounted to the bottom of the cleaner body 80.

Reception of an RF signal from an RFID tag 85 and identification of kinds of objects to be cleaned according to the third embodiment are identical to those of the first embodiment except that the present embodiment is applied to an automatic robot cleaner, not a manual cleaner. In the third embodiment, not only revolutions per minute of the fan motor but also the moving speed of the robot cleaner are changed based on the cleaning modes to control the cleaning capacity of the cleaner. For example, the robot cleaner is controlled that the moving speed of the robot cleaner in the carpet mode is lowered than that of the robot cleaner in the laminated paper covered floor mode.

In the third embodiment, the RFID reader 84 is mounted to the bottom of the cleaner body 80 of the automatic robot cleaner, although a bar-code reader may be mounted to the bottom of the cleaner body 80 of the automatic robot cleaner for reading a bar code attached to the object to be cleaned to perform automatic cleaning. Reading of a bar code by the bar-code reader and identification of kinds of objects to be cleaned according to the third embodiment are identical to those of the second embodiment.

As apparent from the above description, cleaning is performed based on cleaning modes individually set for objects to be cleaned. Consequently, the above-described embodiments of the present invention efficiently perform cleaning irrespective of kinds of objects to be cleaned.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A cleaner having a plurality of cleaning modes, comprising:
a reader reading object identification data stored in an object identification medium attached to an object to be cleaned; and
a control unit interpreting the object identification data read by the reader to identify a kind of the object to be cleaned and controlling the cleaner such that the cleaner performs cleaning in a cleaning mode corresponding to the identified kind of the object to be cleaned.

2. The cleaner according to claim 1, further comprising a fan generating a suction force, wherein revolutions per minute of the fan differ among the cleaning modes so as to generate different suction forces in the cleaning modes.

3. The cleaner according to claim 1, further comprising a control information storage unit storing control information including driving levels of components of the cleaner based on the cleaning modes.

4. The cleaner according to claim 1, wherein the object identification medium is a radio frequency identification (RFID) tag, and the reader is an RFID reader receiving object identification data transmitted from the RFID tag.

5. The cleaner according to claim 1, wherein the object identification medium is a bar code, and the reader is a bar-code reader reading a bar code containing object identification data.

6. A cleaner comprising:
a radio frequency identification (RFID) reader transmitting an RF signal to an RFID tag attached to an object to be cleaned, the RFID tag having a certification number, and receiving another RF signal transmitted from the RFID tag; and
a control unit interpreting the RF signal received from the RFID reader to identify a kind of the object to be cleaned and controlling the cleaner such that the cleaner performs cleaning in a cleaning mode corresponding to the identified kind of the object to be cleaned.

7. The cleaner according to claim 6, further comprising a control information storage unit storing control information including driving levels of components of the cleaner based on a plurality of cleaning modes.

8. A cleaning method comprising:
reading object identification data stored in an object identification medium and regarding an object to be cleaned;
interpreting read the object identification data to identify a kind of the object to be cleaned; and
controlling the cleaner to perform cleaning in a cleaning mode corresponding to the identified kind of the object to be cleaned.

9. The method according to claim 8, wherein the object identification medium is an RFID tag having a certification number, and the reading is performed by a radio frequency identification (RFID) reader receiving object identification data transmitted from the RFID tag.

10. The method according to claim 8, wherein the object identification medium is a bar code, and the reader is a bar-code reader reading a bar code containing object identification data.

11. The vacuum cleaner according to claim 9, wherein the RFID tag transmits an RFID signal in response to a received RFID request signal from the RFID reader.

12. The method according to claim 8, wherein the object identification medium is attached to the object.

13. The vacuum cleaner according to claim 8, wherein the object is an item of furniture or a surface.

14. A vacuum cleaning system, comprising:
an object type provider providing a type of an object to be cleaned;
a reading section reading the type of the object to be cleaned; and
a control section selecting one of plural cleaning modes based on the read type of the object to be cleaned and causing a vacuum cleaner to clean the object to be cleaned in the selected cleaning mode.
